(19) United States
(12) Patent Application Publication
(10) Pub. No.: US 2025/0192335 A1
(43) Pub. Date: Jun. 12, 2025

(54) TRACTION BATTERY PACK BARRIER ASSEMBLY

(71) Applicant: Ford Global Technologies, LLC, Dearborn, MI (US)

(72) Inventors: Michael E. Reibling, Sterling Heights, MI (US); Douglas Christian Lipp, Ann Arbor, MI (US); Patrick Roxin, Livonia, MI (US)

(21) Appl. No.: 18/914,435

(22) Filed: Oct. 14, 2024

Related U.S. Application Data
(60) Provisional application No. 63/607,888, filed on Dec. 8, 2023.

(51) Int. Cl. H01M 50/293; H01M 50/233; H01M 50/244; H01M 50/264; H01M 50/317

(52) U.S. Cl. CPC H01M 50/293; H01M 50/233; H01M 50/244; H01M 50/264; H01M 50/317

(57) ABSTRACT

A battery pack system includes a battery pack enclosure housing a battery array, and a barrier assembly within the enclosure. The barrier assembly includes a container and an expandable foam contained within the container. A battery pack barrier providing method, includes positioning a container within an interior of a battery pack enclosure adjacent to at least one component within the interior, introducing an expandable foam into the container, and delivering the expandable foam through the container to at least one interface between the container and the at least one component.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to a barrier assembly used when communicating vent byproducts from battery cells through a battery pack and then to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack system, including: a battery pack enclosure providing an interior; a battery array within the interior; and a barrier assembly within the interior, the barrier assembly having a container and an expandable foam held by the container.

In some aspects, the techniques described herein relate to a battery pack system, wherein the container is a foam container.

In some aspects, the techniques described herein relate to a battery pack system, wherein the container includes at least one passage extending from at least one passage inlet to at least one passage outlet, the expandable foam disposed within the at least one passage.

In some aspects, the techniques described herein relate to a battery pack system, wherein the expandable foam within the at least one passage is a first amount of expandable foam, and further including a second amount of expandable foam disposed outside the at least one passage at an interface between the container and at least one component within the interior.

In some aspects, the techniques described herein relate to a battery pack system, wherein the at least one component includes a battery array, the second amount of expandable foam bonding the container to the battery array.

In some aspects, the techniques described herein relate to a battery pack system, wherein the second amount of expandable foam additionally bonds the container to an interior surface of the battery pack enclosure to block a flow of vent byproducts through an area between the battery array and the interior surface of the battery pack enclosure.

In some aspects, the techniques described herein relate to a battery pack system, wherein the second amount of expandable foam bonds the container to an interior surface of the battery pack enclosure.

In some aspects, the techniques described herein relate to a battery pack system, wherein the second amount of expandable foam is delivered to the interface through the at least one passage.

In some aspects, the techniques described herein relate to a battery pack system, wherein the container is a foam container.

In some aspects, the techniques described herein relate to a battery pack system, wherein the foam container is a structural foam container.

In some aspects, the techniques described herein relate to a battery pack system, wherein the at least one passage inlet opens vertically upward.

In some aspects, the techniques described herein relate to a battery pack system, wherein the expandable foam expands at least a portion of the container against at least one component within the interior.

In some aspects, the techniques described herein relate to a battery pack system, wherein the container is a bladder.

In some aspects, the techniques described herein relate to a battery pack system, wherein the bladder includes at least one outlet, the expandable foam communicated through the at least one outlet to an interface between the bladder and at least one component within the interior.

In some aspects, the techniques described herein relate to a battery pack system, wherein the bladder is a rubber material.

In some aspects, the techniques described herein relate to a battery pack barrier providing method, including: positioning a container within an interior of a battery pack enclosure adjacent to at least one component within the interior; introducing an expandable foam into the container; and delivering the expandable foam through the container to at least one interface between the container and the at least one component.

In some aspects, the techniques described herein relate to a battery pack barrier providing method, further including bonding the container to the at least one component using the expandable foam.

In some aspects, the techniques described herein relate to a battery pack barrier providing method, wherein the container is a structural foam.

In some aspects, the techniques described herein relate to a battery pack barrier providing method, wherein the container is a bladder.

In some aspects, the techniques described herein relate to a battery pack barrier providing method, wherein introducing the expandable foam into the bladder expands the bladder against the at least one component.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of the battery pack of FIG. 1.

FIG. 3 illustrates a top view of the battery pack of FIG. 2 with an enclosure cover removed.

FIG. 4 illustrates a perspective view of a battery cell from the battery pack of FIG. 2.

FIG. 5 illustrates a section view taken at line 5-5 in FIG. 3.

FIG. 6 illustrates a perspective view of a container of a barrier assembly from the battery pack of FIG. 2.

FIG. 7 illustrates a perspective view of the barrier assembly of FIG. 6.

FIG. 8 illustrates a perspective view of a container of a barrier assembly according to another exemplary embodiment of the present disclosure.

FIG. 9 illustrates the section view of FIG. 5 with the barrier assembly of FIG. 8.

### DETAILED DESCRIPTION

This disclosure details exemplary barrier assemblies for a traction battery pack. The barrier assemblies can be used to, for example, block vent byproducts from moving into certain areas during a thermal event. These areas could include, for example, areas containing electronics. These and other features are discussed in greater detail in the following paragraphs.

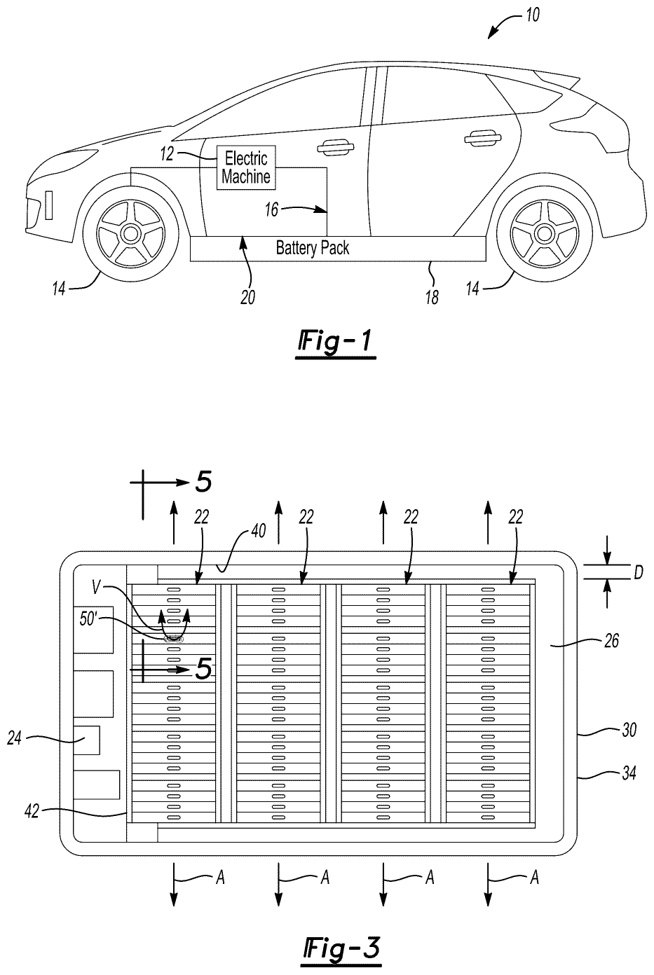

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

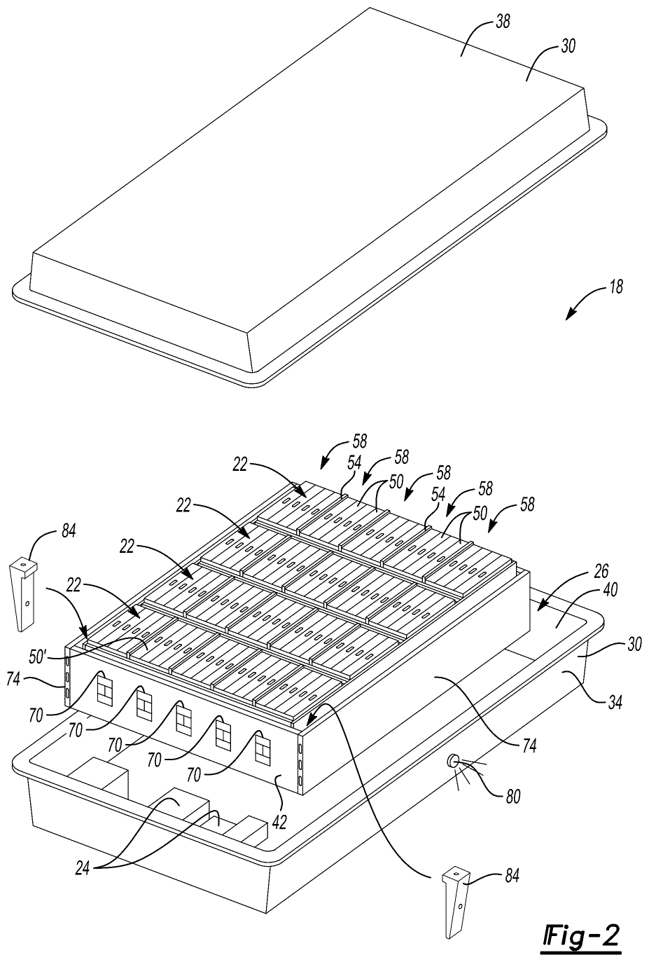

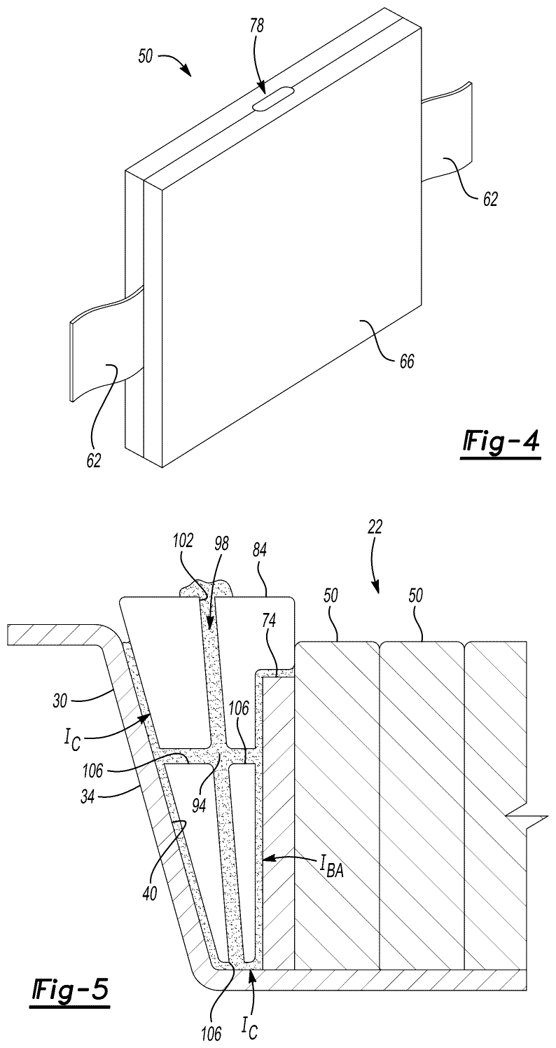

With reference to FIGS. 2 to 4, the example traction battery pack 18 includes a plurality of battery arrays 22 and electronic components 24 housed within an interior 26 of an enclosure assembly 30. Various other components can be housed within the interior 26, such as coolant lines, structural supports, etc. Examples of the electronic components 24 can include a Bussed Electrical Center (BEC), Battery Electronic Control Module (BECM), Fuses, DCDC converters or other such components.

In this example, the enclosure assembly 30 includes an enclosure tray 34 and an enclosure cover 38. The enclosure tray 34 and the enclosure cover 38 cooperate to provide the interior 26. The battery arrays 22 can be spaced a distance D from an interior surface 40 of the enclosure assembly 30.

Within the interior 26, each of the battery arrays 22 is disposed between a pair of busbar frames 42 and positioned upon a thermal exchange plate. Although a specific number of the battery arrays 22 are illustrated in the various figures of this disclosure, the traction battery pack 18 could include any number of the battery arrays 22.

Each battery array 22 can include a plurality of battery cells 50 and a plurality of thermal barriers 54 stacked side-by-side relative to each other along a battery array axis A. In this example, the battery cells 50 are segregated into groups 58 of at least two battery cells 50 that are separated from each other along the respective battery array axis A by one of the thermal barriers 54. The battery cells 50 store and supply electrical power for powering various components of the electrified vehicle 10.

In the exemplary embodiment, the battery cells 50 are lithium-ion pouch-style battery cells. However, battery cells having other geometries (cylindrical, prismatic, etc.) and/or chemistries (nickel-metal hydride, lead-acid, etc.) could alternatively be used within the scope of this disclosure.

The battery cells 50 each include tab terminals 62 extending from a case 66. In the assembled battery pack 18, the tab terminals 62 of the example battery cells 50 extend through an opening in one of the busbar frames 42 to connect to a busbar 70 that is secured to the one of the busbar frames 42.

In the example embodiment, one of two structural members 74 spans across the ends of the battery arrays 22 on a driver side of the battery pack 18. The other of the structural members 74 spans across the ends of the battery arrays 22 on a passenger side of the battery pack 18. The structural members 74 can be extruded beams.

In this example, the battery arrays 22 and the busbar frames 42 extend longitudinally in a cross-vehicle direction of the electrified vehicle 10. The example busbar frames 42 and the battery arrays 22 each span from the structural members 74 on a driver side of the traction battery pack 18 to another of the structural members 74 on a passenger side of the battery pack 18. Among other functions, the busbar frames 42 can be configured to help hold the battery arrays 22 and at least partially delineate the battery arrays 22 from one another within the interior 26.

From time to time, pressure and thermal energy within at least one of the battery cells 50 in the battery arrays 22 can increase. This can lead to the battery cell 50 discharging a flow of vent byproducts V, which can include gas and debris, from within the battery cell 50. In this example, the battery cell 50′ The vent byproducts V can be discharged from the battery cell 50 through designated cell vent 78 within the case 66 of the battery cell 50. The cell vent 78 can be a membrane that yields in response to increased pressure and thermal energy within the battery cell 50. The cell vent 78 can instead simply be a ruptured area of the battery cell 50.

The vent byproducts V can move from the case 66 into another area of the interior 26. The vent byproducts V can be then be communicated through an enclosure vent 80 within the enclosure assembly 30. The enclosure vent 80 releases the vent byproducts V to an area outside the enclosure assembly 30 of the traction battery pack 18.

The example battery pack 18 includes features that help to block the vent byproducts V from moving into certain areas of the interior 26 prior to being discharged through the enclosure vent 80. As an example, the battery pack 18 includes at least one barrier assembly 84 disposed within the interior 26.

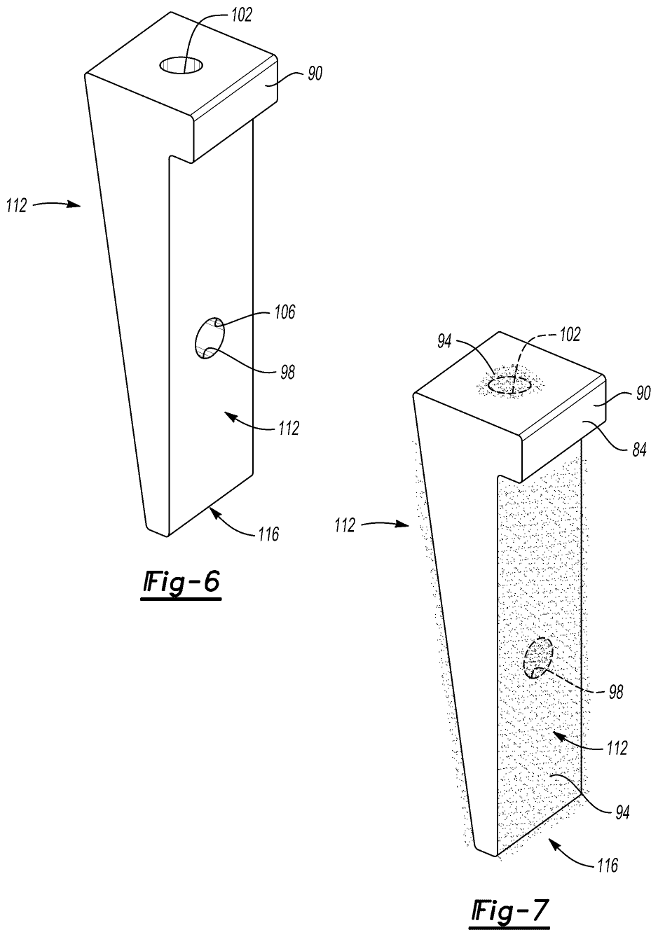

With reference now to FIGS. 5-7 and continuing reference to FIGS. 2-4, the example barrier assemblies 84 are positioned within an area of the interior 26 between the battery arrays 22 and an interior surface 40 of the enclosure assembly 30. The barrier assemblies 84 are positioned to block flow of vent byproducts V through this area so that the vent byproducts V do not move into the area of the interior 26 containing the electronic components 24, which can, in some examples, be particularly sensitive to vent byproducts V.

The barrier assemblies 84 of the exemplary embodiment includes a container 90 and an expandable foam 94 held within the container 90. The example container 90 is a foam container. The container 90 can be made of a relatively rigid foam.

The example container 90 includes a passage 98 extending from a passage inlet 102 through the container 90 to a plurality of passage outlets 106. The expandable foam 94 is held within the passage 98 of the container 90. The inlet 102 faces vertically upward in this example. Vertical and horizontal, for purpose of this disclosure, are with reference to ground in a general orientation of the battery pack during assembly and operation.

The outlets 106 open to horizontally facing sides 112 of the container 90 and a downward facing side 116 of the container 90. One of the outlets 106 opens to the battery array 22. The other outlets 106 open to the interior surface 40 of the enclosure assembly 30.

To position the barrier assembly 84 during assembly, the container 90 can be placed within the enclosure assembly 30 substantially wedged between the battery array 22 and the interior surface 40 of the enclosure assembly 30. The expandable foam 94 is then introduced into the passage 98 through the inlet 102. The expandable foam 94 can be sprayed into the passage 98 in some examples.

A first amount of the expandable foam 94 substantially fills the passage 98 and cures within the passage 98. A second amount of the expandable foam 94 moves through the passage 98 and exits the passage 98 through one of the outlets 106. This second amount of the expandable foam 94 is delivered through the passage 98 to an interface I_{BA} between the container 90 and the battery array 22, or to interfaces I_{C} between the container 90 and the interior surface 40 of the enclosure assembly 30.

The expandable foam 94, when cured, substantially seals the interfaces I_{C} and I_{BA} and holds the position of the container 90 within the area between the battery array 22 and the interior surface 40. The container 90 substantially constrains a position of the expandable foam 94 until the expandable foam 94 has cured and can help to make sure the expandable foam 94 is delivered to the appropriate areas.

After the expandable foam 94 is cured to secure the barrier assembly 84 in a desired position, the remaining portions of the battery pack 18 can be assembled. During operation, the barrier assembly 84 can then be relied on to block the vent byproducts V from moving toward the electronic components 24 within the interior 26.

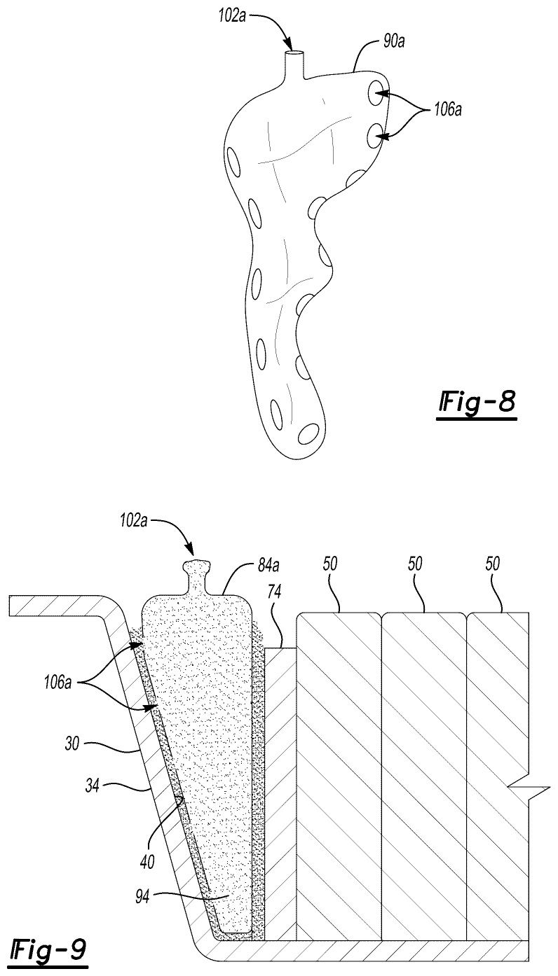

Referring now to FIGS. 8 and 9, another example barrier assembly 84a includes a container 90a. In this example, the container 90a is a bladder. The container 90a can be a rubber material

The container 90a includes a inlet 102a and at least one outlet 106a. Expandable foam 94 can move into the container 90a through the inlet 102a and fills the container 90a. The expandable foam 94 fills an interior of the container 90a and expands the container 90a against components within the interior 26, such as the battery array 22, the enclosure assembly 30, or both. Expanding the expandable foam 94 within the container 90a can cause the container 90a and the remaining portions of the barrier assembly 84a to conform to a profile of the adjacent interfaces to facilitate sealing these interfaces. A wall thickness of the container 90a can be varies to control expansion. In some examples, the container 90a can expand up to six millimeters in a given direction when the container 90a is filled with expandable foam.

Some of the expandable foam 94 moves from the interior of the container 90a through the outlets 106a. This expandable foam 94 can cure to bond the container 90a and the barrier assembly 84a to the enclosure assembly 30, the battery array 22, or both.

In some examples, the battery pack 14 could include other structures used to control and position the expandable foam 94 until the expandable foam 94 has cured. For example, the enclosure tray 34 could include a projection from the interior surface 40 that controls and position the expandable foam 94 until the expandable foam 94 has cured.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack system, comprising:
a battery pack enclosure providing an interior;
a battery array within the interior; and
a barrier assembly within the interior, the barrier assembly having a container and an expandable foam held by the container.

2. The battery pack system of claim 1, wherein the container is a foam container.

3. The battery pack system of claim 1, wherein the container comprises at least one passage extending from at least one passage inlet to at least one passage outlet, the expandable foam disposed within the at least one passage.

4. The battery pack system of claim 3, wherein the expandable foam within the at least one passage is a first amount of expandable foam, and further comprising a second amount of expandable foam disposed outside the at least one passage at an interface between the container and at least one component within the interior.

5. The battery pack system of claim 4, wherein the at least one component includes a battery array, the second amount of expandable foam bonding the container to the battery array.

6. The battery pack system of claim 5, wherein the second amount of expandable foam additionally bonds the container to an interior surface of the battery pack enclosure to block a flow of vent byproducts through an area between the battery array and the interior surface of the battery pack enclosure.

7. The battery pack system of claim 4, wherein the second amount of expandable foam bonds the container to an interior surface of the battery pack enclosure.

8. The battery pack system of claim 4, wherein the second amount of expandable foam is delivered to the interface through the at least one passage.

9. The battery pack system of claim 3, wherein the container is a foam container.

10. The battery pack system of claim 9, wherein the foam container is a structural foam container.

11. The battery pack system of claim 3, wherein the at least one passage inlet opens vertically upward.

12. The battery pack system of claim 1, wherein the expandable foam expands at least a portion of the container against at least one component within the interior.

13. The battery pack system of claim 1, wherein the container is a bladder.

14. The battery pack system of claim 13, wherein the bladder includes at least one outlet, the expandable foam communicated through the at least one outlet to an interface between the bladder and at least one component within the interior.

15. The battery pack system of claim 14, wherein the bladder is a rubber material.

16. A battery pack barrier providing method, comprising:
positioning a container within an interior of a battery pack enclosure adjacent to at least one component within the interior;
introducing an expandable foam into the container; and
delivering the expandable foam through the container to at least one interface between the container and the at least one component.

17. The battery pack barrier providing method of claim 16, further comprising bonding the container to the at least one component using the expandable foam.

18. The battery pack barrier providing method of claim 16, wherein the container is a structural foam.

19. The battery pack barrier providing method of claim 16, wherein the container is a bladder.

20. The battery pack barrier providing method of claim 19, wherein introducing the expandable foam into the bladder expands the bladder against the at least one component.
